(19) United States
(12) Patent Application Publication
(10) Pub. No.: US 2012/0147942 A1
(43) Pub. Date: Jun. 14, 2012

(54) System and Method for Signaling and Detecting in Wireless Communications Systems

(75) Inventors: Christian Schlegel, Park City, UT (US); Tao Wu, Carlsbad, CA (US); Yajun Kou, San Diego, CA (US); Young Hoon Kwon, San Diego, CA (US)

(73) Assignee: FutureWei Technologies, Inc., Plano, TX (US)

(21) Appl. No.: 12/965,568

(22) Filed: Dec. 10, 2010

(51) Int. Cl. H04L 27/06; H04L 27/01

(52) U.S. Cl. 375/229; 375/340; 375/341

(57) ABSTRACT

A system and method for signaling and detecting in wireless communications systems are provided. A method for processing information includes operating in a first phase, and operating in a second phase in response to determining that a first user is transmitting at a substantially higher power level than a second user, and processing the detected information. The first phase includes iteratively inverting a first filtering operation on received signals, and the second phase includes iteratively inverting a second filtering operation on received signals with consideration given to a first estimation error of symbols of the first user and a second estimation error of symbols of the second user. The operating remains in the first phase in response to determining that the first user is not transmitting at a substantially higher power level than the second user.

### TECHNICAL FIELD

The present invention relates generally to a system and method for wireless communications, and more particularly to a system and method for signaling and detecting in wireless communications systems.

### BACKGROUND

Generally, in a wireless communications system, such as a cellular communications system, cell edge users (also known as users, mobiles, mobile stations, subscribers, etc., operating at or near an edge of a coverage area of a base station, also commonly referred to as a NodeB, enhanced NodeB, base terminal station, communications controller, cell, and so forth) may need to carefully control the transmit power level of their transmissions in order to limit interference in cells of close-by neighboring base stations. The transmit power level of the cell edge users may be set by the base station and/or the cell edge users themselves.

The control of the transmit power level may result in lower received signal powers at the base station than would otherwise be possible. As a consequence, a sector/frequency band serving a cell edge user may need to be carefully kept free of interference in order to assure adequate data rates.

### SUMMARY OF THE INVENTION

These and other problems are generally solved or circumvented, and technical advantages are generally achieved, by preferred embodiments of the present invention which provide a system and method for signaling and detecting in wireless communications systems.

In accordance with a preferred embodiment of the present invention, a method for processing received information is provided. The method includes detecting information in received signals based on soft symbol estimates of information in the received signals, and processing the detected information. The detecting makes use of an iterative technique.

In accordance with another preferred embodiment of the present invention, a receiver is provided. The receiver includes an iterative demodulator coupled to a plurality of signal inputs, and a further processing unit coupled to the iterative demodulator. The iterative demodulator detects information in a time-domain representation of received signals based on soft estimates of the information, and the further processing unit provides further processing of soft estimates of the information based on transmit power levels of the information.

In accordance with another preferred embodiment of the present invention, a communications device is provided. The communications device includes a transmitter, and a receiver coupled to the transmitter. The transmitter transmits signals, and the receiver receives signals and detects information in the received signals using iterative information processing on a time-domain representation of the received signals.

An advantage of an embodiment is that careful sector/frequency band planning for cell edge users may not be as crucial in providing adequate performance, which may allow for better frequency band utilization and simplify communications system planning

A further advantage of an embodiment is that different power levels of received signals at the receiver (due to path loss and/or careful transmit power level planning) may be used to separate different mobile signals via simple iterative cancellation or filter-enhanced iterative cancellation to allow for better overall communications rates.

The foregoing has outlined rather broadly the features and technical advantages of the present invention in order that the detailed description of the embodiments that follows may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram of a communications system;

FIG. 2 is a diagram of a communications system, wherein a detailed view of a receiver is provided;

FIG. 3 is a detailed view of a portion of a first receiver;

FIG. 4a is a flow diagram of operations occurring at a communications device in processing received signals;

FIG. 4b is a flow diagram of operations in a communications device as the communications device iteratively solves for information contained in a received signal; and

FIG. 5 is an alternate illustration of a communications device.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a 3GPP LTE compliant communications system. The invention may also be applied, however, to other communications systems, such as those that are compliant to the technical standards of 3GPP LTE-Advanced, WiMAX, and so forth.

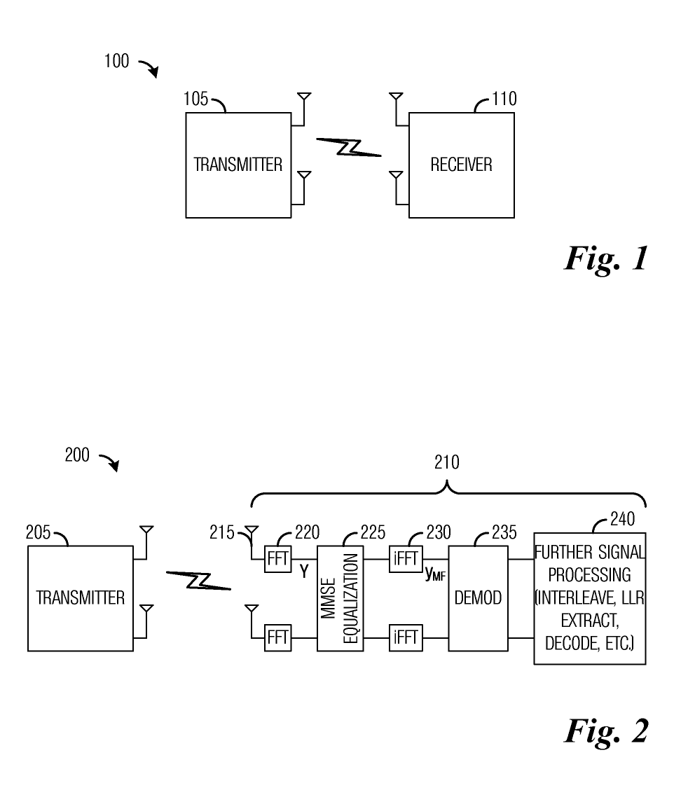

FIG. 1 illustrates a communications system 100. As shown in FIG. 1 a, communications system 100 includes a transmitter 105 and a receiver 110. As shown in FIG. 1, both transmitter 105 and receiver 110 may include multiple antennas (multiple transmit and/or receive antennas) and therefore may be capable of operating in a multiple-input, multiple-output (MIMO) mode. Transmitter 105 may be a part of a first communications device, such as an eNB, and receiver 110 may be a part of a second communications device, such as a UE. The first communications device and the second communications device may include other circuitry, such as other receivers and transmitters, as well as analog signal processing circuitry, digital signal processing circuitry, data processing circuitry, and so forth.

Although not shown, electronic devices may be coupled to transmitter 105 and/or receiver 110. Examples of electronic devices may include a computer, personal digital assistant, media server, media player, or so forth, may be coupled to transmitter 105 and/or receiver 110 to be able to communicate with other electronic devices. Alternatively, transmitter 105 and/or receiver 110 may be integrated into electronic devices. Generally, an electronic device will include both a transmitter and a receiver to enable two-way communications.

Receiver 110 may include multiple signal chains, one for each receive antenna. Although receiver 110 may include multiple signal chains, not all of them may be active at once. In general, a number of signal chains active in receiver 110 may depend on an operating mode of receiver 110. Therefore, the discussion of a specific number of signal chains should not be construed as being limiting to either the scope or spirit of the embodiments. Furthermore, in the interest of clarity, only components of receiver 110 relevant to the embodiments will be discussed herein. It should be understood that receiver 110 includes a number of components that may be required for operation but are not discussed. These components may include memories, amplifiers, filters, analog-to-digital converters, digital-to-analog converters, and so forth.

In general, receiver 110 may take signals received at its receive antennas and decode the received signals to produce information that may be used by applications to control the operation of receiver 110 or device coupled to receiver 110, stored for subsequent use, provided to a user of the device coupled to receiver 110 (e.g., music, videos, photos, text, data, applications, etc.), transmitting to another device, or so forth. The accuracy of the information produced by receiver 110 as compared to information contained in the signals as transmitted by transmitter 105 may be a function of the quality of the channel, the strength of a code (if any) used to encode the information transmitted by transmitter 105, and so forth.

FIG. 2 illustrates a communications system 200, wherein a detailed view of a receiver is provided. Communications system 200 includes a transmitter 205 transmitting to a receiver 210. Receiver 210 may be indicative of a receiver of a communications device in a 3GPP LTE compliant communications system. Receiver 210 may be operating in a MIMO operating mode. Receiver 210 may include two or more receive antennas, with each antenna feeding a separate signal path. The discussion provided focuses on a single signal path with other signal paths of receiver 210 being substantially similar. Any significant differences will be noted.

A signal received by antenna 215 may be a time-domain signal. A discrete Fourier transform unit 220 may convert the time-domain signal into a frequency-domain signal using a Fast Fourier Transform (FFT), for example. The frequency-domain signal may be channel matched or equalized with equalization unit 225, which may implement minimum mean-squared equalization (MMSE), for example. Equalization unit 225 may equalize frequency-domain signals from each of the antennas (signal paths), and also implement spatial filtering to separate the different signal from the multiple-antenna received signal. The equalized signals may be converted back into time-domain signals by an inverse Fourier transform unit 230 using an inverse Fast Fourier Transform (iFFT), for example, or directly processed if the data is already encoded in the frequency domain. The former occurs on the LTE uplink, and the latter on the LTE downlink channels.

Time-domain versions of the equalized signals may be provided to a demodulator 235 that may be used to provide Quadrature Phase Shift Keying (QPSK)/Quadrature Amplitude Modulation (QAM) demodulation. A further processing unit 240 may provide processing, such as interleaving, log likelihood ratio (LLR) extraction, turbo decoding, and so forth, to the demodulated signal. After further processing, data extracted from the received signal may be provided to circuitry attached to receiver 210, where it may be further processed, stored, displayed, or so on.

A factor in the quality of the signal received at a receiver may be the signal's received power. Since a distance between transmitter and receiver impacts a received signal's power level, wherein typically the greater the distance between transmitter and receiver the lower the received signal's power level. A commonly used technique in multi-user communications systems is to use transmit power control to set a transmitter's power control so that all received signals are at substantially the same power level, independent of distance between the receiver and the various transmitters. Therefore, a receiver that is far away from the receiver will need to transmit at a higher power level than a receiver that is close to the receiver. For example, a cell edge user may have it's transmit power adjusted so that it does not become an overwhelming interferer to users that are operating in neighboring cells. However, such high-power transmitters may become significant sources of interference to other, unintended receivers.

In 3GPP LTE compliant communications systems, uplink (UL) signaling uses a time-domain signal that is transformed into a frequency-domain signal for transmission. Let v₁ be a sequence of time-domain symbols (per block) of user #1. In order to modulate the signal on orthogonal frequency-division multiplexing (OFDM) carriers of 3GPP LTE compliant communications systems, a discrete Fourier transform (DFT) may be applied. The resulting signal may be expressed as

x^{(f)}=ZF_{M}v, (1)

where Z is a frequency selection matrix. In a situation where there are transmissions from multiple users, a back-transformed received signal may be expressed as

$$y = \sqrt{{P}_{1}} {v}_{1} + {\sum }_{k \neq 1}^{K} {F}_{M}^{H} {Z}_{k}^{( - 1 )} {Z}_{1} {F}_{M} \sqrt{{P}_{i}} {v}_{k} + σ n ; n \sim {\{ ℵ ( 0 , 1 ) \}}^{M} , \qquad ( 2 )$$

where Zₖ⁽⁻¹⁾Z₁ a kernel matrix and selects only those OFDM channels which are shared by users #1 and k. A middle term in Equation (2)

$$( {\sum }_{k \neq 1}^{K} {F}_{M}^{H} {Z}_{k}^{( - 1 )} {Z}_{1} {F}_{M} \sqrt{{P}_{i}} {v}_{k} )$$

is the joint user interference as seen from user #1.

A conventional receive may treat the interference as noise with variance

$${σ}^{2} + {\sum }_{k \neq 1}^{K} {α}_{k} {P}_{k} ,$$

where αₖ is the fraction of OFDM frequencies users #1 and k share. In general, it may be possible to express the frequency-domain signal in matrix form as

y^{(f)}=HF_{M}v+σn,

where the channel matrix combines transmission effects and frequency selection of the different users, i.e., Zₖ.

In advanced 3GPP LTE processing, a minimum mean-squared error (MMSE) receiver as in equalization unit 225 in FIG. 2 would suppress the mutual interference and extract individual data streams using

$$[ \begin{matrix}{\hat{v}}_{1} \\ ⋮ \\ {\hat{v}}_{K}\end{matrix} ] = {F}_{M}^{H} {{H}^{H} ( {H}^{H} H + {σ}^{2} I )}^{- 1} {y}^{( f )} . \qquad ( 3 )$$

However, the MMSE receiver may be effective only if the interference is small with respect to P₁, which requires multiple receive antennas or signal spreading to sufficiently suppress interference. If

$${P}_{1} << {\sum }_{i = 2}^{K} {P}_{i} ,$$

linear filtering may not recover the signal with sufficient signal-to-noise ratio.

In certain situations it may be computationally preferable to reverse the order of the matched filtering with that of inversion. Using the matrix inversion lemma, it may be possible to obtain

$$[ \begin{matrix}{\hat{v}}_{1} \\ ⋮ \\ {\hat{v}}_{K}\end{matrix} ] = {{F}_{M}^{H} ( {H}^{H} H + {σ}^{2} I )}^{- 1} {H}^{H} {y}^{( f )} . \qquad ( 4 )$$

In general, Equation (4) may be computationally more efficient if the row rank of H is smaller than its column rank. Processing may be particularly simple if K=1, and only single-antenna terminals are used. In such a situation, the matrix to be inverted is purely diagonal. However, if K≠1, the inversion complexity increases.

Under certain circumstances, like those discussed herein, it may be beneficial to translate processing to the time-domain. Processing in the time-domain may be done by introducing Fourier transform kernels as follows (note that FM=F to de-clutter notation)

$$\begin{matrix}[ \begin{matrix}{\hat{v}}_{1} \\ ⋮ \\ {\hat{v}}_{K}\end{matrix} ] = {{F}^{H} ( {H}^{H} H + {σ}^{2} I )}^{- 1} {FF}^{H} {H}^{H} {y}^{( f )} \\ = {( {F}^{H} {H}^{H} H F + {σ}^{2} I )}^{- 1} {F}^{H} {H}^{H} {y}^{( f )} \\ = {( \tilde{H} + {σ}^{2} I )}^{- 1} {F}^{H} {H}^{H} {y}^{( f )} \\ = {( \tilde{H} + {σ}^{2} I )}^{- 1} {y}_{mf} ,\end{matrix} \qquad ( 5 )$$

where matched filtering is performed in the frequency domain by H^{H}, and \tilde{H} is a time domain (TD) channel correlation matrix with circulant form.

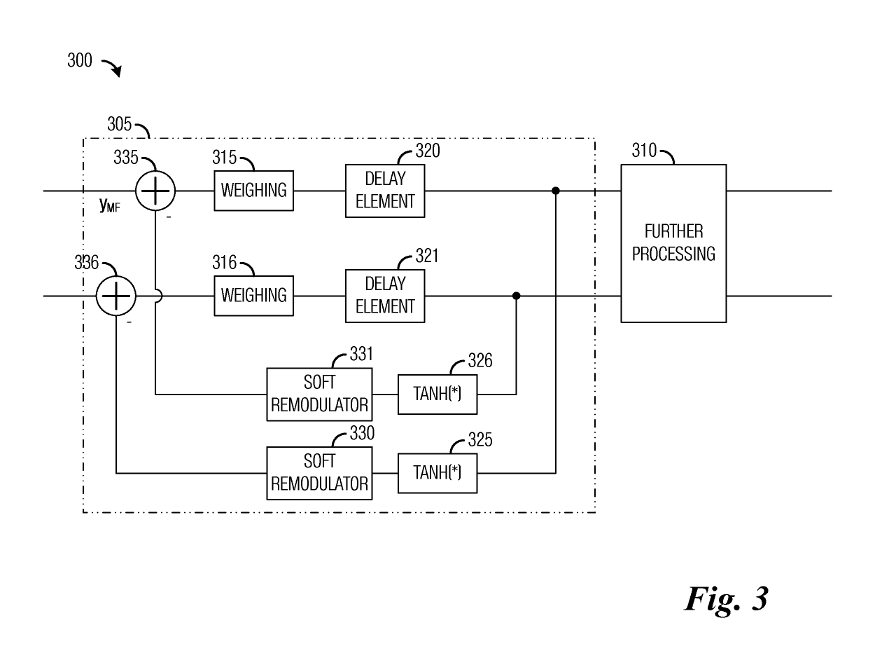

FIG. 3 illustrates a detailed view of a portion of a receiver 300. In the time domain, it may be possible to invert the matrix shown in Equation (5) with an iterative structure rather than using direct algebraic inversion. FIG. 3 shows such a structure and implements what is known as an iterative matrix solution algorithm. A conjugate-gradient (CG) iterative approximation to matrix inversion in Equation (5) may yield good results and significant complexity savings over frequency-domain inversion may be possible, particularly for larger numbers of users and antennas.

As shown in FIG. 3, a demodulation unit 305 and a further processing unit 310 are illustrated in detail. Demodulation unit 305 may be an implementation of an iterative approach to demodulating the signals received by a receiver. Demodulation unit 305 may be an implementation of demodulation unit 235 of receiver 210 of FIG. 2. Further processing unit 310 may be an implementation of further signal processing unit 240 of receiver 210 of FIG. 2. Typically, further processing occurring in further processing unit 310 consists of error control decoding, for example, in a 3GPP LTE compliant communications system, a turbo code decoder is used which may produce log-likelihood estimates of the transmitted binary symbols.

Demodulation unit 305 and further processing unit 310, collectively referred to as an iterative structure, approximate a linear MMSE filter with an iterative implementation that utilizes symbol estimates in recursion, and efficient signal cancellation may be achieved in a few iterations.

For discussion purposes, let receiver 300 be a two-antenna receiver, and therefore has two signal paths. When used in a receiver with a different number of receive antennas, there may necessarily be a different number of signal paths. Although the discussion focuses on a receiver with two receive antennas, the embodiments discussed herein may be operable with other numbers of receive antennas, such as three, four, and so forth. Therefore, the discussion of a receiver with two receive antennas should not be construed as being limiting to either the scope or the spirit of the embodiments.

A first signal path (for signals from a first receive antenna) includes a weighing unit 315 may be used to apply a weighting factor to the first received signal. According to an embodiment, weighing unit 315 may apply a weighting factor that is based on a user whose signal is being detected and may be dependent on factors such as a received power level of the user's signals. To arrive at the weighting factor(s), additional computational steps may be required, for example, in the computing update factors in a conjugate gradient method. A delay element 320 may be used to insert a delay into the first signal path in order to properly align signals for processing. According to an embodiment, delay element 320 may also include as a bit log-likelihood ratio extractor, in which case an output of delay element 320 may be log-likelihood ratios of binary digits embedded in the first received signal.

The first signal path also includes a soft bit generator 325. Soft bit generator 325 may compute soft bits (or soft symbol estimates) from the delayed and weighted signal received from the first signal path. According to an embodiment, soft bit generator 325 may be implemented using a hyperbolic tangent (tan h(.)) function. However, other non-linear functions, adapted to specific signal constellations, may be used to generate soft bits and soft symbols, therefore, the discussion of the use of tan h(.) to generate soft bits should not be construed as being limiting to either the scope or spirit of the embodiments. A soft-symbol remodulator 330 may be used to remodulate the soft bits generated by soft bit generator 325. According to an embodiment, a soft estimate of the first signal may be reconstructed using soft bit generator 325 and soft-symbol remodulator 330.

Also in the first signal path is a summing point 335 that subtracts remodulated soft bits from a second signal path (e.g., a soft estimate of the second signal) from the weighted first signals. The cross coupling of the two signal paths allow for a cancellation of signals from different users/streams. Also, depending on the specific implementation of the equalizer (for example, equalizer 225), interference of the first signal stream to itself may also be present, in which case soft remodulation symbols are also fed back to the first signal path for cancellation in summing point 335. The particular embodiment discussed in FIG. 3 assumes that such interference does not exist, or has been appropriately cancelled by equalizer 225. Focus on this special structure shall not be construed as exclusive, and more general interference cancellation including self interference shall be considered a natural application of the concepts herein.

A second signal path similarly includes a weighing unit 316, a delay element 321, a soft bit generator 326, a soft-symbol remodulator 331, and a summing point 336. Like in the first signal path, summing point 336 subtracts remodulated soft bits from the first signal path (e.g., a soft estimate of the first signal) from the weighed second signals. According to an embodiment, circuitry in the second signal path may be configured in a manner similar to circuitry in the first signal path.

In other words, the iterative structure shown in FIG. 3 computes Equation (5) as an iterative update for a first order update method as

vⁱ⁺¹=tan h(vⁱ)+T(y_{mf}−(\tilde{H}+σ²I) tan h(vⁱ)), (6)

where T=diag(τ₁, . . . , τ_{K}), in general. The values of T may need to be chosen to accelerate performance and improve overall results. For example, consider a two-user system where one user's power P₁>>P₂. In this case, the symbols of v₁ will naturally converge faster than those of v₂. A controller may be used to adjust T and Σ such that τ₁→0 for iterations i>Iₛ. Therefore, the stronger signals that have converged will be cancelled, and no longer contribute to the process. The effect may be seen by substituting Equation (5) into Equation (7) and rewriting the latter for the two-user example as (with σ²=0 for clarity)

$$[ \begin{matrix}{v}_{1}^{i + 1} \\ {v}_{2}^{i + 1}\end{matrix} ] = [ \begin{matrix}tanh ( {v}_{1}^{i} ) \\ tanh ( {v}_{2}^{i} )\end{matrix} ] + T ( {F}^{H} {H}^{H} H F ( v - tanh ( {v}^{i} ) ) + {F}^{H} {H}^{H} n ) . \qquad ( 7 )$$

As can be seen in Equation (7), τ₁→0 removes user #1 from the iterative process. Other choices of weights may also be possible and may be carefully optimized.

A system corresponding to Equation (2) may be formally similar to that of a code division multiple access (CDMA) communications system with K users. Therefore, conclusions drawn regarding CDMA joint signaling may be directly applied. In particular,

1. It may be possible to define load factors

$$β = {\sum }_{k \neq 1}^{K} {α}_{k} {P}_{k} / M$$

and loads of up to β=2 may be supported theoretically for Pₖ=P₁, ∀k . That is, the number of users in a sector may be doubled.

2. When different power Pₖ is allowed, load factors β>2 may be supported. Load factors greater than two implies that users close to the base station, signals from which are naturally received with more power, should not be power-controlled down since their larger received power is beneficial in the general coexistence of users in the same sector.

3. Frequency occupation may carefully be chosen to generate resolvable interference only.

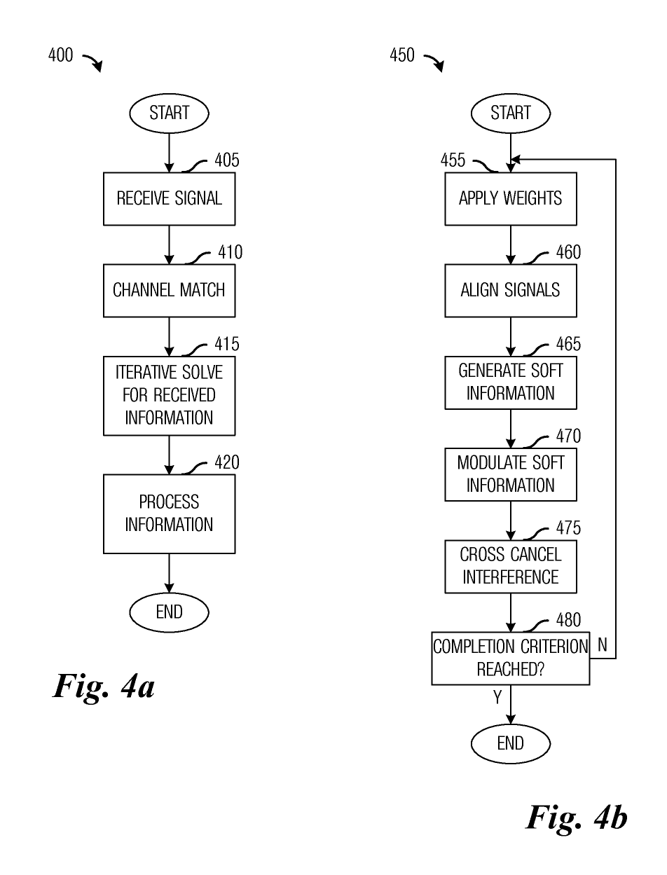

FIG. 4a illustrates a flow diagram of operations 400 occurring at a communications device in processing received signals. Operations 400 may be indicative of operations occurring in a communications device, such as a communications controller, a base station, mobile station, or so on, with an iterative signal processor for cancelling interference from multiple users to help improve communications performance. Operations 400 may occur while the communications device is in a normal operating mode.

Operations 400 may begin with the communications device receiving signals from a plurality of transmitters (block 405). According to an embodiment, the plurality of transmitters may not need to utilize power control in order to regulate the transmit power of their transmissions so that the signals received by the communications device are at substantially equal power levels. In fact, differences in received signal power levels may be exploited by the communications device to improve overall performance.

The received signal may be converted into a frequency domain signal, which may then be channel matched or equalized (block 410). According to an embodiment, channel matching may be performed by an equalizer, such as a MMSE equalizer. After frequency-domain channel matching or equalization, the frequency-domain signal may be converted back into a time-domain signal.

According to an embodiment, the communications device may solve the time-domain signal for information contained in the received signal (block 415). As discussed previously, the communications device may determine the information by solving Equation (5) shown above. According to an embodiment, the communications device may iteratively compute updates for the information (v), which may be expressible as

vⁱ⁺¹=tan h(vⁱ)+T(y_{mf}−(\tilde{H}+σ²I) tan h(vⁱ)),

where T=diag(τ₁, . . . , τ_{K}), in general.

With the information in the received signal determined, the communications device may process the information (block 420). Operations 400 may then terminate.

FIG. 4b illustrates a flow diagram of operations 450 in a communications device as the communications device iteratively solves for information contained in a received signal. Operations 450 may be indicative of operations occurring in a communications device, such as a communications controller, a base station, a mobile station, or so forth, as the communications device determines information contained in the received signal (preferably in the time domain) using an iterative update method. Operations 450 may occur while the communications device is in a normal operating mode.

Operations 450 may begin with the communications device applying weights to the received signal (block 455). According to an embodiment, the weights (T) may be selected to implement an iterative filtering technique, such as a MMSE filter. The values of T may need to be chosen to accelerate performance and improve overall results. After the weights are applied to the received signal, time alignment of the received signal may be performed (block 460). According to an embodiment, delay(s) may be inserted in the received signal in a first signal path to align it with the received signal in a second signal path. Preferably, a bit log-likelihood ratio extractor may be used to insert delays in the received signal.

With the received signal in the signal paths aligned, soft information may be generated (block 465). For example, a soft bit generator may be used to compute soft bits from the delayed and weighed received signal. According to an embodiment, a non-linear function, such as a hyperbolic tangent function (tan h(.)) may be used to compute the soft information (i.e., the soft bits).

The soft information may be modulated (block 470) and used to cross cancel interference (block 475). For example, the soft information in the first signal path may be modulated and used to cross cancel interference in the second signal path, and vice versa. The communications device may then perform a check to determine if a completion criterion has been reached (block 480). Examples of the completion criterion may be a convergence criterion, an iteration count, or so forth. If the completion criterion is not reached, the communications device may return to block 455 to continue the iterative solving for information in the received signal. If the completion criterion is complete, then operations 450 may then terminate.

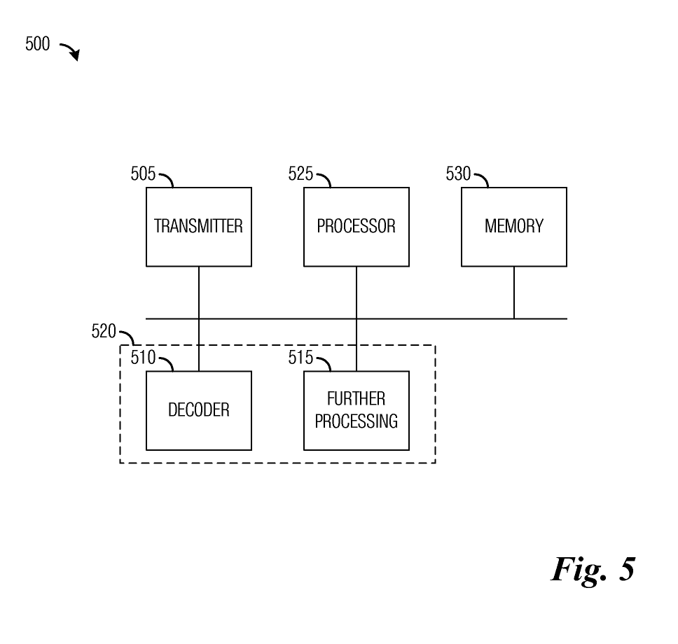

FIG. 5 provides an alternate illustration of a communications device 500. Communications device 500 may be used to implement various ones of the embodiments discussed herein. As shown in FIG. 5, a transmitter 505 is configured to transmit information. A decoder 510 is configured to decode information contained in the received signals using an iterative technique. A further processing unit 515 is configured to provide further processing, such as error control decoding to soft estimates computed in decoder 510. Collectively, decoder 510 and further processing unit 515 may be part of a receiver 520.

A processor 525 is configured to process information decoded from received signals by receiver 520. A memory 530 is configured to store information, as well as values to be used in decoding of information from the received signal by receiver 520.

The elements of communications device 500 may be implemented as specific hardware logic blocks. In an alternative, the elements of communications device 500 may be implemented as software executing in a processor, controller, application specific integrated circuit, or so on. In yet another alternative, the elements of communications device 500 may be implemented as a combination of software and/or hardware.

As an example, transmitter 505 may be implemented as a specific hardware block, while receiver 520 (decoder 510 and further processing unit 515) may be software modules executing in a microprocessor or a custom circuit or a custom compiled logic array of a field programmable logic array.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for processing received information, the method comprising:
detecting information in received signals based on soft symbol estimates of information in the received signals, wherein the detecting makes use of an iterative technique; and
processing the detected information.

2. The method of claim 1, wherein the received signals comprises a first received signal at a first signal power level and a second received signal at a second signal power level, and wherein the first signal power level is significantly greater than the second signal power level.

3. The method of claim 1, wherein detecting information comprises iteratively filtering the received signals.

4. The method of claim 3, wherein iteratively filtering the received signals comprises:
computing a first soft symbol estimate;
computing a second soft symbol estimate;
combining the second soft symbol estimate with a first received signal; and
combining the first soft symbol estimate with a second received signal.

5. The method of claim 4, wherein computing a first soft symbol estimate comprises:
applying a first weighting factor to the first received signal, thereby producing a weighed first received signal;
generating a first soft symbol estimate from the weighed first received signal; and
remodulating the first soft symbol estimate.

6. The method of claim 5, wherein generating a first soft symbol estimate comprises applying a non-linear function to the weighed first received signal.

7. The method of claim 6, wherein the non-linear function comprises a hyperbolic tangent function.

8. The method of claim 5, wherein computing a second soft symbol estimate comprises:
applying a second weighting factor to the second received signal, thereby producing a weighed second received signal;
generating a second soft symbol estimate from the weighed second received signal; and
remodulating the second soft symbol estimate.

9. The method of claim 8, further comprising aligning the weighed first received signal and the weighed second received signal.

10. The method of claim 3, wherein iteratively filtering the received signals comprises iteratively inverting a matrix representation of a filter.

11. The method of claim 10, wherein the filter comprises a minimum mean squared error filter or a zero forcing filter.

12. The method of claim 1, further comprising equalizing a frequency-domain representation of the received signals.

13. A receiver comprising:
an iterative demodulator coupled to a plurality of signal inputs, the iterative demodulator configured to detect information in a time-domain representation of received signals based on soft estimates of the information; and
a further processing unit coupled to the iterative demodulator, the further processing unit configured to provide further processing of soft estimates of the information based on transmit power levels of the information.

14. The receiver of claim 13, wherein the iterative demodulator comprises:
a first weighing unit configured to apply a first weighting factor to a received signal;
a first soft estimate generator coupled to the first weighing unit, the first soft estimate generator configured to generate a first soft estimate of information in the received signal; and
a first remodulator coupled to the first soft estimate generator, the first remodulator configured to apply a modulation to the first soft estimate.

15. The receiver of claim 14, wherein the iterative demodulator further comprises a first delay element coupled to the first weighing unit and to the first soft estimator, the first delay element configured to insert a delay to the received signal.

16. The receiver of claim 15, wherein the first delay element is configured to extract log likelihood ratio values from the received signal.

17. The receiver of claim 16, wherein the iterative demodulator further comprises a first summing point having an input coupled to a second remodulator and an output coupled to the first weighing unit, the first summing point configured to combine the received signal and an output produced by the second remodulator.

18. The receiver of claim 17, wherein the iterative demodulator further comprises:
a second weighing unit configured to apply a second weighting factor to the received signal;
a second soft estimate generator coupled to the second weighing unit, the second soft estimate generator configured to generate a second soft estimate of information in the received signal; and
a second summing point having an input coupled to the first remodulator and an output coupled to the second weighing unit, the second summing point configured to combine the received signal and an output produced by the first remodulator,
wherein the second remodulator is coupled to the second soft estimate generator, and the second remodulator is configured to apply a modulation to the second soft estimate.

19. A communications device comprising:
a transmitter configured to transmit signals; and
a receiver coupled to the transmitter, the receiver configured to receive signals and to detect information in the received signals using iterative information processing on a time-domain representation of the received signals.

20. The communications device of claim 19, wherein the receiver comprises:
an iterative demodulator configured to be coupled to a plurality of signal inputs, the iterative demodulator configured to detect information in the time-domain representation of the received signals based on soft estimates of the information; and
a further processing unit coupled to the iterative demodulator, the further processing unit configured to determine estimation errors.

21. The communications device of claim 20, wherein the iterative demodulator comprises:
a first weighing unit configured to apply a first weighting factor to a received signal;
a first soft estimate generator coupled to the first weighing unit, the first soft estimate generator configured to generate a first soft estimate of information in the received signal;
a first remodulator coupled to the first soft estimate generator, the first remodulator configured to apply a modulation to the first soft estimate; and
a first summing point having an input coupled to a second remodulator and an output coupled to the first weighing unit, the first summing point configured to combine the received signal and an output produced by the second remodulator.
